(19) United States
(12) Patent Application Publication
(10) Pub. No.: US 2016/0162842 A1
(43) Pub. Date: Jun. 9, 2016

(54) MESSAGING SYSTEM AND METHOD

(71) Applicant: Dogpatch Technology, Inc., San Francisco, CA (US)

(72) Inventors: Jean Kay Miller Truelson, San Francisco, CA (US); John Palmer Truelson, San Francisco, CA (US)

(21) Appl. No.: 14/959,766

(22) Filed: Dec. 4, 2015

Related U.S. Application Data
(60) Provisional application No. 62/087,479, filed on Dec. 4, 2014.
(60) Provisional application No. 62/087,501, filed on Dec. 4, 2014.

(51) Int. Cl. G06Q 10/10; G06F 17/30

(52) U.S. Cl. CPC G06Q 10/1095; G06F 17/30115

(57) ABSTRACT

A computer-implemented method, computer program product, and computing system for defining an event schedule for a first user, wherein the event schedule identifies one or more personal discrete events of the first user. A second user is enabled to define one or more personal media files. A selected media file is associated with a selected discrete event. The selected media file is chosen from the one or more personal media files and the selected discrete event is chosen from the one or more personal discrete events.

### RELATED APPLICATION

This application claims the benefit of U.S. Provisional Patent Application No. 62/087,479, entitled “Healthcare Reminder System and Method” and filed on 4 Dec. 2014; the entire contents of which are herein incorporated by reference.

This application claims the benefit of U.S. Provisional Patent Application No. 62/087,501, entitled “Healthcare Reminder System and Method” and filed on 4 Dec. 2014; the entire contents of which are herein incorporated by reference.

### TECHNICAL FIELD

This disclosure relates to messaging systems and, more particularly, to messaging systems that monitor events associated with one user so that other users may send event-specific messages to them.

### BACKGROUND

When a person is dealing with an ailment, they often need to follow various schedules, examples of which may include but are not limited to: doctor's appointment schedules, exercise schedules, physical therapy schedules, testing schedules, medication schedules, and treatment schedules.

Unfortunately, the person that needs to adhere to these schedules may have a difficult time doing the same. For example, the person may be an elderly patient and may have a difficult time remembering their doctor's appointments. Alternatively, the person may be depressed due to being diagnosed within an illness and may lack the motivation to adhere to their treatment schedule.

### SUMMARY OF DISCLOSURE

In one implementation, a computer-implemented method, executed on a computing device, includes defining an event schedule for a first user, wherein the event schedule identifies one or more personal discrete events of the first user. A second user is enabled to define one or more personal media files. A selected media file is associated with a selected discrete event. The selected media file is chosen from the one or more personal media files and the selected discrete event is chosen from the one or more personal discrete events.

One or more of the following features may be included. The selected media file may be provided to the first user temporally proximate the selected discrete event. The one or more discrete events may include one or more of: at least one provider event, at least one personal event, and at least one medication event. The event schedule may include one or more of: a doctor's appointment schedule, an exercise schedule, a physical therapy schedule, a medication schedule, and a personal schedule. The one or more personal media files may include one or more of: at least one image file, at least one video file, at least one audio file, and at least one message file. The first user may include a patient that is receiving a particular treatment. The second user may include one or more of a family member of the first user, a friend of the first user, a supporter of the first user, a volunteer for the first user, and a third party.

In another implementation, a computer program product resides on a computer readable medium that has a plurality of instructions stored on it. When executed by a processor, the instructions cause the processor to perform operations including defining an event schedule for a first user, wherein the event schedule identifies one or more personal discrete events of the first user. A second user is enabled to define one or more personal media files. A selected media file is associated with a selected discrete event. The selected media file is chosen from the one or more personal media files and the selected discrete event is chosen from the one or more personal discrete events.

One or more of the following features may be included. The selected media file may be provided to the first user temporally proximate the selected discrete event. The one or more discrete events may include one or more of: at least one provider event, at least one personal event, and at least one medication event. The event schedule may include one or more of: a doctor's appointment schedule, an exercise schedule, a physical therapy schedule, a medication schedule, and a personal schedule. The one or more personal media files may include one or more of: at least one image file, at least one video file, at least one audio file, and at least one message file. The first user may include a patient that is receiving a particular treatment. The second user may include one or more of a family member of the first user, a friend of the first user, a supporter of the first user, a volunteer for the first user, and a third party.

In another implementation, a computing system includes at least one processor and at least one memory architecture coupled with the at least one processor, wherein the computing system is configured to perform operations including defining an event schedule for a first user, wherein the event schedule identifies one or more personal discrete events of the first user. A second user is enabled to define one or more personal media files. A selected media file is associated with a selected discrete event. The selected media file is chosen from the one or more personal media files and the selected discrete event is chosen from the one or more personal discrete events.

One or more of the following features may be included. The selected media file may be provided to the first user temporally proximate the selected discrete event. The one or more discrete events may include one or more of: at least one provider event, at least one personal event, and at least one medication event. The event schedule may include one or more of: a doctor's appointment schedule, an exercise schedule, a physical therapy schedule, a medication schedule, and a personal schedule. The one or more personal media files may include one or more of: at least one image file, at least one video file, at least one audio file, and at least one message file. The first user may include a patient that is receiving a particular treatment. The second user may include one or more of a family member of the first user, a friend of the first user, a supporter of the first user, a volunteer for the first user, and a third party.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a messaging process according to an implementation of the present disclosure;

FIG. 2 is a flowchart of a first implementation of the messaging process of FIG. 1 according to an implementation of the present disclosure; and

FIG. 3 is a flowchart of a second implementation of the messaging process of FIG. 1 according to an implementation of the present disclosure.

Like reference symbols in the various drawings indicate like elements.

### DETAILED DESCRIPTION OF THE PREFERRED EMBODIMENTS

### System Overview:

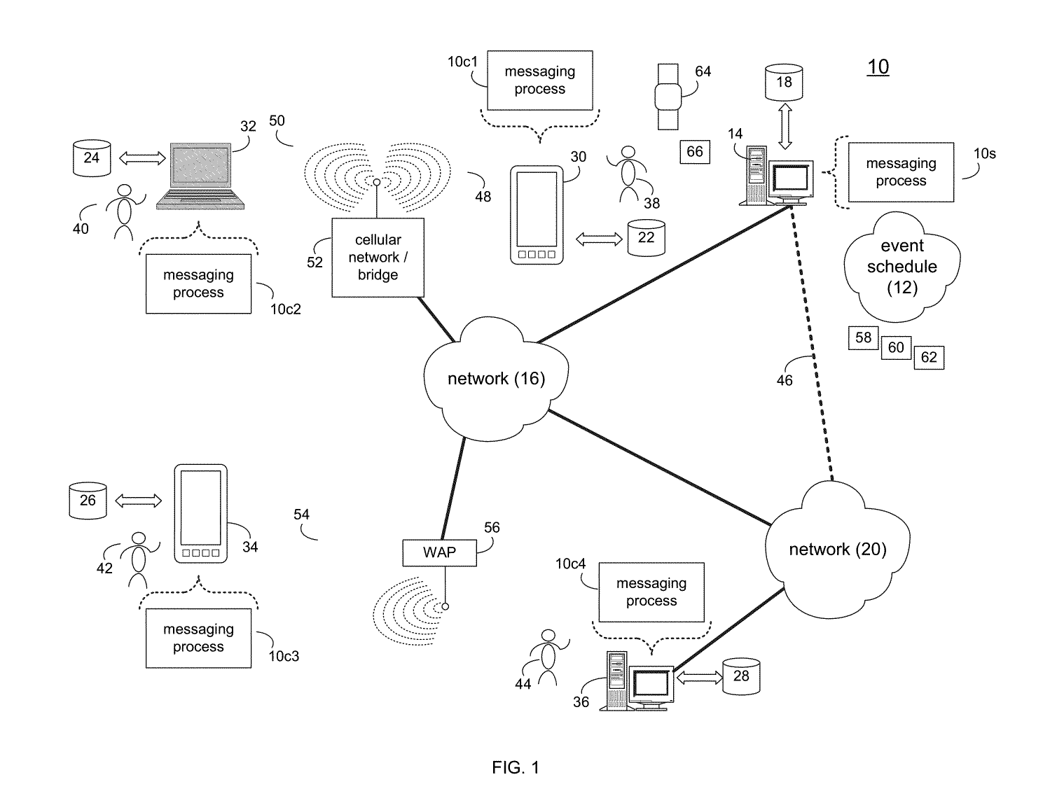

Referring to FIG. 1, there is shown messaging process 10. As will be discussed below in greater detail, messaging process 10 may be utilized to monitor the status of a user (e.g., a patient) and an event schedule (e.g., event schedule 12) associated with the user so that third parties (i.e., other users) may send messages to the user concerning e.g., the status of the user and events associated with the user.

Messaging process 10 may be implemented as a server-side process, a client-side process, or a hybrid server-side/client-side process. For example, messaging process 10 may be implemented as a purely server-side process via server-side messaging process 10s. Alternatively, messaging process 10 may be implemented as a purely client-side process via one or more of client-side messaging process 10c1, client-side messaging process 10c2, client-side messaging process 10c3, and client-side messaging process 10c4. Alternatively still, messaging process 10 may be implemented as a hybrid server-side/client-side process via server-side messaging process 10s in combination with one or more of client-side messaging process 10c1, client-side messaging process 10c2, client-side messaging process 10c3, and client-side messaging process 10c4. Accordingly, messaging process 10 as used in this disclosure may include any combination of server-side messaging process 10s, client-side messaging process 10c1, client-side messaging process 10c2, client-side messaging process 10c3, and client-side messaging process 10c4.

Server-side messaging process 10s may be a server application and may reside on and may be executed by computing device 14, which may be connected to network 16 (e.g., the Internet or a local area network). Examples of computing device 14 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of server-side messaging process 10s, which may be stored on storage device 18 coupled to computing device 14, may be executed by one or more processors (not shown) and one or more memory architectures (not shown) included within computing device 14. Examples of storage device 18 may include but are not limited to: a hard disk drive; a tape drive; an optical drive; a RAID device; a random access memory (RAM); a read-only memory (ROM); and all forms of flash memory storage devices.

Network 16 may be connected to one or more secondary networks (e.g., network 20), examples of which may include but are not limited to: a local area network; a wide area network; or an intranet, for example.

Examples of client-side messaging processes 10c1, 10c2, 10c3, 10c4 may include but are not limited to a web browser, a specialized desktop application, a game console user interface, or a specialized handheld application (e.g., an application running on e.g., the Android™ platform or the iPhone™ platform). The instruction sets and subroutines of client-side messaging processes 10c1, 10c2, 10c3, 10c4, which may be stored on storage devices 22, 24, 26, 28 (respectively) coupled to client electronic devices 30, 32, 34, 36 (respectively), may be executed by one or more processors (not shown) and one or more memory architectures (not shown) incorporated into client electronic devices 30, 32, 34, 36 (respectively). Examples of storage devices 22, 24, 26, 28 may include but are not limited to: hard disk drives; tape drives; optical drives; RAID devices; random access memories (RAM); read-only memories (ROM), and all forms of flash memory storage devices.

Examples of client electronic devices 30, 32, 34, 36 may include, but are not limited to, data-enabled, cellular telephone 30, laptop computer 32, personal digital assistant 34, personal computer 36, a notebook computer (not shown), a server computer (not shown), a gaming console (not shown), a smart television (not shown), and a dedicated network device (not shown). Client electronic devices 30, 32, 34, 36 may each execute an operating system, examples of which may include but are not limited to Microsoft Windows™, Android™, WebOS™, iOS™, Redhat Linux™, or a custom operating system.

Users 38, 40, 42, 44 may access messaging process 10 directly through network 16 or through secondary network 20. Further, messaging process 10 may be connected to network 16 through secondary network 20, as illustrated with link line 46.

The various client electronic devices (e.g., client electronic devices 30, 32, 34, 36) may be directly or indirectly coupled to network 16 (or network 20). For example, data-enabled, cellular telephone 30 and laptop computer 32 are shown wirelessly coupled to network 16 via wireless communication channels 48, 50 (respectively) established between data-enabled, cellular telephone 30, laptop computer 32 (respectively) and cellular network/bridge 52, which is shown directly coupled to network 16. Further, personal digital assistant 34 is shown wirelessly coupled to network 16 via wireless communication channel 54 established between personal digital assistant 34 and wireless access point (i.e., WAP) 56, which is shown directly coupled to network 16. Additionally, personal computer 36 is shown directly coupled to network 20 via a hardwired network connection.

WAP 56 may be, for example, an IEEE 802.11a, 802.11b, 802.11g, 802.11n, Wi-Fi, and/or Bluetooth device that is capable of establishing wireless communication channel 54 between personal digital assistant 34 and WAP 56. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Messaging Process:

Assume for the following example that user 38 utilizes data-enabled, cellular telephone 30 to access messaging process 10. Further assume that user 38 is a patient that is receiving a particular treatment (e.g., a cancer patient that is receiving chemotherapy). As discussed above, messaging process 10 may be utilized to monitor the status of a user (e.g., user 38) and an event schedule (e.g., event schedule 12) associated with user 38 so that third parties (e.g., users 40, 42, 44) may send messages to user 38 concerning e.g., the status of user 38 and events associated with user 38.

### Event Monitoring:

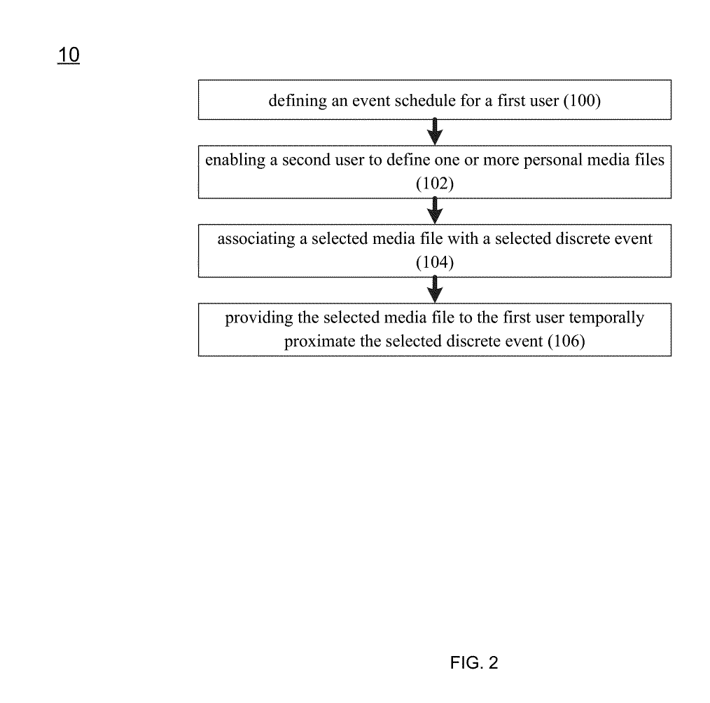

Referring also to FIG. 2 and concerning the manner in which messaging process 10 may be utilized to monitor an event schedule (e.g., event schedule 12) associated a user (e.g., user 38) so that third parties (e.g., users 40, 42, 44) may send messages to user 38, messaging process 10 may define 100 event schedule 12 for user 28. For example, messaging process 10 may be configured to allow user 38 to create and maintain event schedule 12. For example and through the use of data-enabled, cellular telephone 30, user 38 may define 100 event schedule 12 that may function as e.g., a cloud-based calendar that identifies one or more personal discrete events concerning (in this example) the treatment of user 38. Examples of these discrete events may include but are not limited to one or more of: provider events, personal events, and medication events.

Accordingly, examples of event schedule 12 may include but are not limited to one or more of: a doctor's appointment schedule (e.g., that identifies various doctor's appointments), an exercise schedule (e.g., that identifies various scheduled exercises), a physical therapy schedule (e.g., that identifies various physical therapy appointments), a medication schedule (e.g., that identifies dosages and frequencies of medications) and/or a personal schedule (e.g., that identifies other events such as lab work appointments and/or follow up calls with medical professionals).

Continuing with the above-stated example, assume that user 38 uses messaging process 10 to define 100 event schedule 12 to include a personal discrete event for each chemotherapy treatment scheduled for user 38. For example, assume that user 38 is schedule to receive a chemotherapy treatment at 9:00 a.m. each Monday morning for eight sequential weeks. Accordingly, messaging process 10 may define 100 event schedule 12 to include eight personal discrete events, namely one for each of the chemotherapy treatments that are scheduled for user 38 for 9:00 a.m. on eight consecutive Mondays.

Messaging process 10 may enable 102 a second user (e.g., user 40, 42, 44) to define one or more personal media files (e.g., personal media files 58, 60, 62). Examples of these second users (e.g., user 40, 42, 44) may include but are not limited to one or more of a family member of user 38 (e.g., a parent, sibling or relative of user 38), a friend of user 38 (e.g., a childhood friend or a coworker of user 38), a supporter of user 38 (e.g., a unrelated supporter of user 38), a volunteer for user 38 (e.g., an unrelated volunteer for user 38), and a third party concerning user 38 (e.g., a paid service provider for user 38).

Examples of these personal media files may include but are not limited to one or more of: at least one image file (e.g., a photograph of a grandchild of user 38), at least one video file (e.g., a video of a daughter of user 38), at least one audio file (e.g., an audio recording of a grandchild singing a song to user 38), and at least one message file (e.g., a text-based reminder). Additionally, these file types may be combined to form hybrid media files (e.g., a meme file that includes an image of a granddaughter of user 38 with the text “Get Well Soon” superimposed over the image).

For the following example, user 38 may use messaging process 10 to grant users 40, 42, 44 access to event schedule 12, as event schedule 12 may include health-related information for user 38. Further, messaging process 10 may associate 104 a selected media file with a selected discrete event, wherein the selected media file may be chosen from the one or more personal media files 58, 60, 62 and the selected discrete event may be chosen from the one or more personal discrete events defined within event schedule 12. One example of this association 104 of the selected media file with the selected discrete event may include but is not limited to the second user (e.g., users 40, 42, 44) selecting the specific media file (chosen from the one or more personal media files 58, 60, 62) to be associated 104 with the selected discrete event. Another example of this association 104 of the selected media file with the selected discrete event may include but is not limited to messaging process 10 selecting the specific media file (chosen from the one or more personal media files 58, 60, 62) to be associated 104 with the selected discrete event.

For example, assume that user 38 is scheduled to go to their first chemotherapy on Monday morning and user 40 (e.g., the mother of user 38) knows that user 38 is nervous and scared concerning this first appointment. Accordingly, user 40 may record an upbeat audio recording (e.g., personal media file 58) that says “You will be fine and we can't wait until you are well again”. Messaging process 10 may be configured to allow user 40 to generate this audio recording (e.g., personal media file 58) or (alternatively) user 40 may utilize a third party application/utility to generate personal media file 58. User 40 may then associate 104 personal media file 58 with e.g., the first chemotherapy appointment for user 38. Alternatively, messaging process 10 may randomly associate a personal media file (chosen from the one or more personal media files 58, 60, 62) with e.g., the first chemotherapy appointment for user 38.

Once a selected media file (e.g., personal media file 58) is associated 104 with the selected discrete event (e.g., the first chemotherapy appointment for user 38), messaging process 10 may provide 106 the selected media file (e.g., personal media file 58) to user 38 temporally proximate the selected discrete event (e.g., the first chemotherapy appointment for user 38). For example, on Monday morning at 7:00 a.m., messaging process 10 may provide 106 personal media file 58 to user 38, thus providing an upbeat greeting to user 38 that (hopefully) may calm the nerves of user 38 (in this example).

### Status Monitoring:

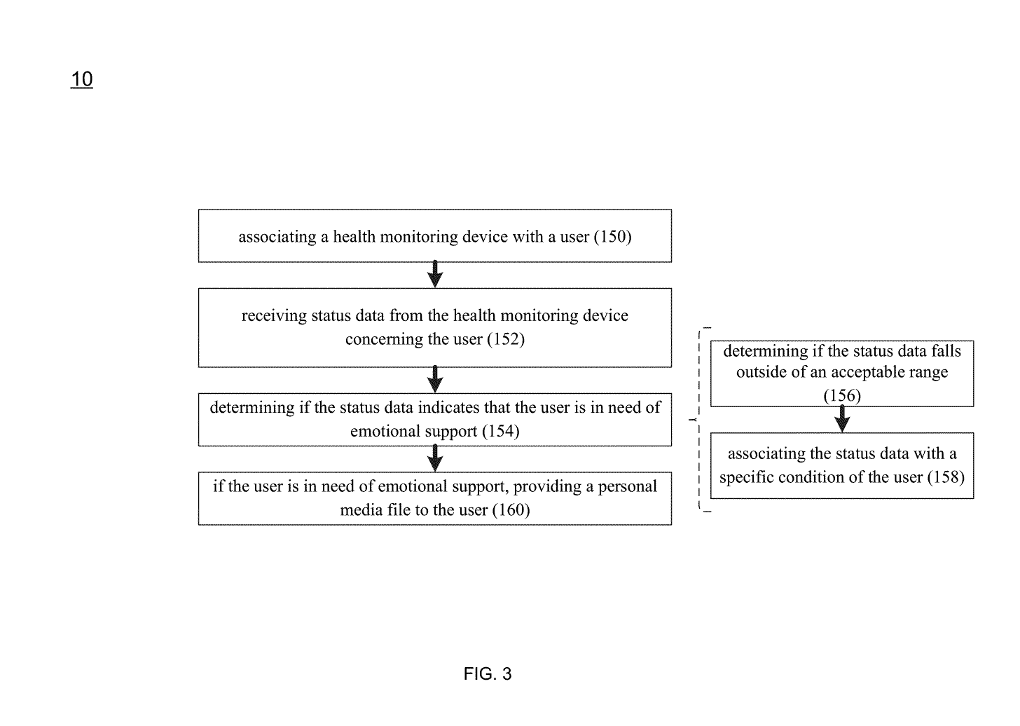

Referring also to FIG. 3 and concerning the manner in which messaging process 10 may be utilized to monitor the status of a user (e.g., user 38) so that third parties (e.g., users 40, 42, 44) may send messages to user 38, messaging process 10 may associate 150 a health monitoring device (e.g., health monitoring device 64) with e.g., user 38. Examples of health monitoring device 64 may include but are not limited to one or more of: an activity monitoring system (e.g., a wirelessly-coupled Fitbit™ device), a blood glucose monitoring system (e.g., a wirelessly-coupled glucose monitor), a blood pressure monitoring system (e.g., a wirelessly-coupled blood pressure monitoring system), and a weight monitoring system (e.g., a wirelessly-coupled scale).

As discussed above, health monitoring device 64 may be a wirelessly-coupled device. Accordingly, messaging process 10 may receive 152 status data (e.g., status data 66) from health monitoring device 64 concerning user 38. Examples of status data 66 may include but is not limited to one or more of: activity data concerning user 38, sleep quality data concerning user 38, blood glucose readings concerning user 38, blood pressure reading concerning user 38, and/or weight/fat content/BMI readings concerning user 38.

Once status data 66 concerning user 38 is received 152, messaging process 10 may determine 154 if status data 66 indicates that user 38 is in need of emotional support. When determining 154 if status data 66 indicates that user 38 is in need of emotional support, messaging process 10 may determine 156 if status data 66 falls outside of an acceptable range. For example, assume that status data 66 concerns the quantity of sleep that user 38 receives per night. Accordingly, if user 38 should be sleeping approximately eight hours per night and health monitoring device 64 (and status data 66) indicates that user 38 is sleeping less than seven hours per night, messaging process 10 may determine 156 that status data 66 falls outside of the acceptable range and, therefore, that user 38 is in need of emotional support.

Additionally/alternatively, when determining 154 if status data 66 indicates that user 38 is in need of emotional support, messaging process 10 may associate 158 status data 66 with a specific condition of user 38. Examples of the specific condition of user 38 may include but are not limited to one or more of: a mood of user 38, an attitude of user 38, and a health condition of user 38. For example, assume that status data 66 concerns the blood glucose level of user 38 as measured in the morning. Accordingly, if user 38 should have a blood glucose level of <140 mg/dL when measured at 8:00 a.m. and health monitoring device 64 (and status data 66) indicates that user 38 has a blood glucose level of 178 mg/dL, messaging process 10 may associate 158 status data 66 with a specific condition (e.g., high blood sugar) and, therefore, that user 38 is in need of emotional support.

If messaging process 10 determines 154 that user 38 is in need of emotional support, messaging process 10 may provide 160 a personal media file to user 38, chosen from a plurality of available personal media files (e.g., personal media files 58, 60, 62). Specifically, one or more of users 40, 42, 44 may be notified that user 38 is in need of emotional support and (via messaging process 10) one or more of users 40, 42, 44 may select a personal media file so that messaging process 10 may provide 160 this selected personal media file to user 38.

As discussed above, examples of personal media files 58, 60, 62 may include but are not limited to one or more of: an image file (e.g., a photograph of a grandchild of user 38), a video file (e.g., a video of a daughter of user 38), an audio file (e.g., an audio recording of a grandchild singing a song to user 38), and a message file (e.g., a text-based reminder). Further and as discussed above, these file types may be combined to form hybrid media files (e.g., a meme file). Additionally and as discussed above, messaging process 10 may be configured to allow users (e.g., users 40, 42, 44) to generate these personal media files (e.g., personal media files 58, 60, 62) or alternatively users 40, 42, 44 may utilize a third party application/utility to generate personal media files 58, 60, 62.

Accordingly, if (as discussed above) user 38 should be sleeping approximately eight hours per night and health monitoring device 64 (and status data 66) indicates that user 38 is sleeping less than seven hours per night, messaging process 10 may provide 160 e.g., a personal media file to user 38 that is e.g., an audio recording of the grandson of user 38 asking user 38 to get more sleep. Further, if (as discussed above) user 38 should have a blood glucose level of <140 mg/dL when measured at 8:00 a.m. and health monitoring device 64 (and status data 66) indicates that user 38 has a blood glucose level of 178 mg/dL, messaging process 10 may provide 160 e.g., a personal media file to user 38 that is e.g., a video recording of the mother of user 38 asking user 38 to exercise more and/or eat less carbohydrates.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data management processing apparatus, such that the instructions, which execute via the processor of the computer or other programmable data management processing apparatus, create means for implementing the functions/acts specified in the flowchart and/or block diagram block or blocks.

These computer program instructions may also be stored in a computer-readable memory that may direct a computer or other programmable data management processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data management processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
defining an event schedule for a first user, wherein the event schedule identifies one or more personal discrete events of the first user;
enabling a second user to define one or more personal media files; and
associating a selected media file with a selected discrete event;
wherein the selected media file is chosen from the one or more personal media files and the selected discrete event is chosen from the one or more personal discrete events.

2. The computer-implemented method of claim 1 further comprising:
providing the selected media file to the first user temporally proximate the selected discrete event.

3. The computer-implemented method of claim 1 wherein the one or more discrete events includes one or more of: at least one provider event, at least one personal event, and at least one medication event.

4. The computer-implemented method of claim 1 wherein the event schedule includes one or more of: a doctor's appointment schedule, an exercise schedule, a physical therapy schedule, a medication schedule, and a personal schedule.

5. The computer-implemented method of claim 1 wherein the one or more personal media files includes one or more of: at least one image file, at least one video file, at least one audio file, and at least one message file.

6. The computer-implemented method of claim 1 wherein the first user includes a patient that is receiving a particular treatment.

7. The computer-implemented method of claim 1 wherein the second user includes one or more of a family member of the first user, a friend of the first user, a supporter of the first user, a volunteer for the first user, and a third party.

8. A computer program product residing on a computer readable medium having a plurality of instructions stored thereon which, when executed by a processor, cause the processor to perform operations comprising:
defining an event schedule for a first user, wherein the event schedule identifies one or more personal discrete events of the first user;
enabling a second user to define one or more personal media files; and
associating a selected media file with a selected discrete event;
wherein the selected media file is chosen from the one or more personal media files and the selected discrete event is chosen from the one or more personal discrete events.

9. The computer program product of claim 8 further comprising:
providing the selected media file to the first user temporally proximate the selected discrete event.

10. The computer program product of claim 8 wherein the one or more discrete events includes one or more of: at least one provider event, at least one personal event, and at least one medication event.

11. The computer program product of claim 8 wherein the event schedule includes one or more of: a doctor's appointment schedule, an exercise schedule, a physical therapy schedule, a medication schedule, and a personal schedule.

12. The computer program product of claim 8 wherein the one or more personal media files includes one or more of: at least one image file, at least one video file, at least one audio file, and at least one message file.

13. The computer program product of claim 8 wherein the first user includes a patient that is receiving a particular treatment.

14. The computer program product of claim 8 wherein the second user includes one or more of a family member of the first user, a friend of the first user, a supporter of the first user, a volunteer for the first user, and a third party.

15. A computing system including a processor and memory configured to perform operations comprising:
defining an event schedule for a first user, wherein the event schedule identifies one or more personal discrete events of the first user;
enabling a second user to define one or more personal media files; and
associating a selected media file with a selected discrete event;
wherein the selected media file is chosen from the one or more personal media files and the selected discrete event is chosen from the one or more personal discrete events.

16. The computing system of claim 15 further comprising:
providing the selected media file to the first user temporally proximate the selected discrete event.

17. The computing system of claim 15 wherein the one or more discrete events includes one or more of: at least one provider event, at least one personal event, and at least one medication event.

18. The computing system of claim 15 wherein the event schedule includes one or more of: a doctor's appointment schedule, an exercise schedule, a physical therapy schedule, a medication schedule, and a personal schedule.

19. The computing system of claim 15 wherein the one or more personal media files includes one or more of: at least one image file, at least one video file, at least one audio file, and at least one message file.

20. The computing system of claim 15 wherein the first user includes a patient that is receiving a particular treatment.

21. The computing system of claim 15 wherein the second user includes one or more of a family member of the first user, a friend of the first user, a supporter of the first user, a volunteer for the first user, and a third party.
